(19) United States
(12) Patent Application Publication
(10) Pub. No.: US 2023/0260135 A1
(43) Pub. Date: Aug. 17, 2023

(54) IMAGE CAPTURING APPARATUS, CONTROL METHOD OF IMAGE CAPTURING APPARATUS, AND MEMORY MEDIUM

(71) Applicant: CANON KABUSHIKI KAISHA, Tokyo (JP)

(72) Inventors: NOBUSHIGE WAKAMATSU, Tokyo (JP); KATSUHIRO ITO, Kanagawa (JP)

(21) Appl. No.: 18/159,259

(22) Filed: Jan. 25, 2023

(30) Foreign Application Priority Data
Feb. 16, 2022 (JP) 2022-022412

(51) Int. Cl. G06T 7/246; H04N 23/68; H04N 23/695

(52) U.S. Cl. CPC G06T 7/246; H04N 23/695; H04N 23/6811

(57) ABSTRACT

An image capturing apparatus includes an image capturing unit, a driving unit configured to drive the image capturing unit, and at least one processor. The at least one processor is configured to function as a motion vector detector configured to detect motion vectors based on image data output from the image capturing unit, an object detector configured to detect a plurality of moving objects based on the motion vectors, and a controlling unit configured to perform tracking control by controlling the driving unit. The controlling unit calculates respective evaluation values of the plurality of moving objects based on at least one of (a) information on the plurality of moving objects, (b) information on a shake of the image capturing apparatus, and (c) information on a driving state of the driving unit. The controlling unit controls the driving unit based on the evaluation values.

### BACKGROUND OF THE INVENTION

### Field of the Invention

The aspect of the embodiments relates to an image capturing apparatus, a control method of an image capturing apparatus, and a memory medium.

### Description of the Related Art

Japanese Patent Application Laid-Open No. (“JP”) 2019-106694 discloses an image capturing apparatus that detects a moving object and automatically tracks it.

With the image capturing apparatus disclosed in JP 2019-106694, it is difficult to detect a moving object in a case where the moving object greatly moves, such as a case of a sports scene. In a case where a moving object is to be imaged, it is conceivable to detect the moving object on an image and capture an image centering on the detected moving object, but if automatic tracking is performed exclusively for a specific moving object among a plurality of detected moving objects, the other moving objects may be out of an angle of view. Furthermore, it is difficult to perform proper control because a moving object in the background other than the intended moving obj ect may be erroneously tracked and a non-moving object may be erroneously detected as a moving object or erroneously tracked.

### SUMMARY OF THE INVENTION

The present disclosure provides an image capturing apparatus that can perform control suitable for imaging of a plurality of moving objects.

An image capturing apparatus according to one aspect of the embodiments includes an image capturing unit, a driving unit configured to drive the image capturing unit, and at least one processor. The at least one processor is configured to function as a motion vector detector configured to detect motion vectors based on image data output from the image capturing unit, an object detector configured to detect a plurality of moving objects based on the motion vectors, and a controlling unit configured to perform tracking control by controlling the driving unit. The controlling unit calculates respective evaluation values of the plurality of moving objects based on at least one of (a) information on the plurality of moving objects, (b) information on a shake of the image capturing apparatus, and (c) information on a driving state of the driving unit. The controlling unit controls the driving unit based on the evaluation values.

An image capturing apparatus according to one aspect of the embodiments includes an image capturing unit, a driving unit configured to drive the image capturing unit, and at least one processor. The at least one processor is configured to function as a motion vector detector configured to detect a motion vector based on image data output from the image capturing unit, an object detector configured to detect a moving object based on the motion vector or a specific object, and a controlling unit configured to perform tracking control by controlling the driving unit. The controlling unit sets a reference position for the image capturing unit. The controlling unit determines whether or not to move the image capturing unit to the reference position, based on at least two of (a) a time during which a position of the image capturing unit is away from the reference position, (b) an angular amount by which the position of the image capturing unit is away from the reference position, (c) detection information of the moving object, and (d) detection information of the specific object.

Control methods corresponding to the image capturing apparatuses and non-transitory computer-readable memory mediums storing the control methods also constitute other aspects of the embodiments.

Further features of the present invention will become apparent from the following description of exemplary embodiments with reference to the attached drawings.

### BRIEF DESCRIPTION OF THE DRAWINGS

FIGS. 1A to 1D are external views illustrating an image capturing apparatus according to a first embodiment.

FIG. 2 is a block diagram illustrating the image capturing apparatus according to the first embodiment.

FIG. 3 is an explanatory diagram illustrating communication between the image capturing apparatus and an external apparatus according to the first embodiment.

FIG. 4 is a flowchart illustrating a tracking operation process according to the first embodiment.

FIGS. 5A to 5D are explanatory diagrams illustrating a moving body object detection process according to the first embodiment.

FIG. 6 is an explanatory diagram illustrating the moving body object detection process according to the first embodiment.

FIGS. 7A and 7B are explanatory diagrams illustrating a frequency distribution process according to the first embodiment.

FIGS. 8A to 8D are explanatory diagrams illustrating the tracking operation process according to the first embodiment.

FIGS. 9A to 9C are explanatory diagrams illustrating an operation of the image capturing apparatus according to the first embodiment.

FIG. 10 is a flowchart illustrating imaging processing according to the second embodiment.

FIGS. 11A to 11C are examples of weight calculation tables according to the first embodiment.

### DESCRIPTION OF THE EMBODIMENTS

Referring now to the accompanying drawings, a detailed description is given of embodiments according to the present disclosure. Configurations described in each embodiment are mere examples, and the present disclosure is not limited to the configurations disclosed in each embodiment.

### First Embodiment

### Configuration of Image Capturing Apparatus 101

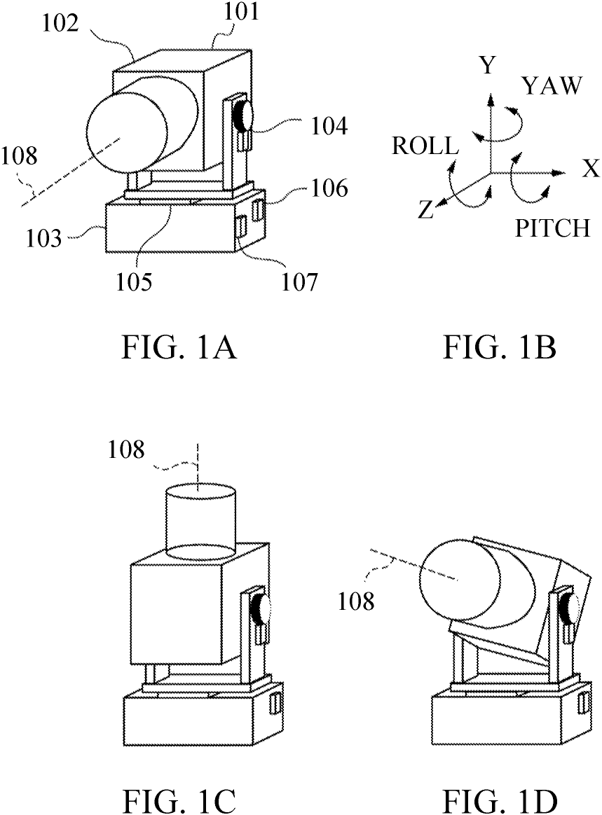

First, with reference to FIGS. 1A to 1D, a description is given of an external configuration of an image capturing apparatus 101 according to the first embodiment. FIGS. 1A to 1D are external views of the image capturing apparatus 101. The image capturing apparatus 101 includes an unillustrated power switch. As illustrated in FIG. 1A, the image capturing apparatus 101 includes an image capturing lens unit (image capturing optical system) for capturing an image and a lens barrel 102 having an image sensor. An image capturing apparatus 101 to which a lens barrel 102 is attached includes a mechanism that can be rotationally driven relatively to a fixed unit 103. A tilting rotating unit 104 includes a motor driving mechanism that rotates the image capturing apparatus 101 in a “pitch direction” (see FIG. 1B). A panning rotating unit 105 includes a motor driving mechanism that rotates the image capturing apparatus 101 in a “yaw direction” (see FIG. 1B).

The tilting rotating unit 104 and the panning rotating unit 105 are included in a panning-tilting unit that performs tilting and panning of the image capturing apparatus 101. A “pitch,” “yaw,” and “roll” in FIG. 1B are rotations about X, Y, and Z axes, respectively. The X-axis, Y-axis, and Z-axis are axes defined by a fixed position of the fixed unit 103.

The fixed unit 103 includes an angular speedometer 106 and an accelerometer 107. Based on outputs from the angular speedometer 106 and the accelerometer 107, a shake of the image capturing apparatus 101 can be detected. The tilting rotating unit 104 and the panning rotating unit 105 are rotationally driven based on a detected shake angle. This makes it possible to compensate for the shake and tilt of the image capturing apparatus 101.

In FIGS. 1A, 1C, and 1D, a reference numeral 108 denotes an optical axis direction. FIG. 1C illustrates a state in which the image capturing apparatus 101 is tilted by 90 degrees from the state in FIG. 1A. FIG. 1D illustrates a state in which the image capturing apparatus 101 is tilted by θ degrees (0 degrees < θ <90 degrees) from the state in FIG. 1A.

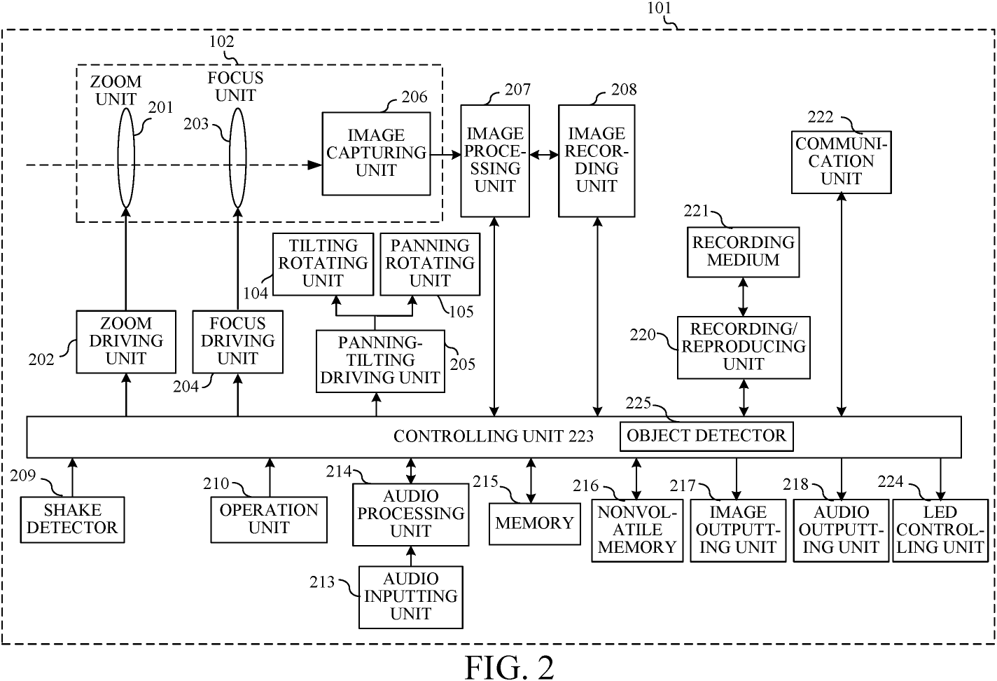

Next, with reference to FIG. 2, a description is given of an internal configuration of the image capturing apparatus 101. FIG. 2 is a block diagram illustrating the image capturing apparatus 101. The controlling unit 223 includes, for example, a CPU (MPU), a memory (DRAM, SRAM), a nonvolatile memory (EEPROM), and the like. By executing a program, the controlling unit 223 realizes control on each part of the image capturing apparatus 101, control on data transfer between parts, and various other functions. A nonvolatile memory 216 is an electrically erasable/recordable memory, and stores parameters, programs, etc. used for the operation of the controlling unit 223. The controlling unit 223 also includes an object detector 225 that detects a plurality of moving body objects (moving objects) based on motion vectors.

The lens barrel 120 includes a zoom unit 201, a focus unit 203, and an image capturing unit 206. The zoom unit 201 includes a zoom lens that varies magnification. A zoom driving unit 202 controls driving of the zoom unit 201. That is, the zoom driving unit 202 varies a focal length of the image capturing optical system. The focus unit 203 includes a lens for focusing. A focus driving unit 204 controls driving of the focus unit 203. The image capturing unit 206 includes an image sensor (not illustrated) on which an image of an object is formed. The image sensor of the image capturing unit 206 is a photoelectric conversion element such as a CMOS sensor and a CCD sensor, receives light entering via the image capturing optical system of the lens barrel 102, and outputs information on electric charges corresponding to the received light amount as analog image data (captured image) to an image processing unit 207.

The image processing unit 207 performs image processing, such as distortion correction, white balance adjustment, and color interpolation processing, on digital image data acquired by converting the analog image data, and outputs the digital image data. The image processing unit 207 also functions as a motion vector detector that detects motion vectors in the image data output from the image capturing unit 206. The image recording unit 208 converts the digital image data output from the image processing unit 207 into a recording format such as a JPEG format. The converted image data is transmitted to a memory 215 and an image outputting unit 217.

A panning-tilting driving unit 205 is a rotating driving unit that drives the tilting rotating unit 104 and the panning rotating unit 105. That is, the panning-tilting driving unit 205 rotationally drives the image capturing apparatus 101 including the lens barrel 102 in a tilting direction and a panning direction. The shake detector 209 includes, for example, an angular speedometer (gyro sensor) 106 that detects angular velocity in three axial directions of the image capturing apparatus 101, and an accelerometer (acceleration sensor) 107 that detects acceleration in three axial directions of the image capturing apparatus 101. Based on the detected signal, the rotation angle of the image capturing apparatus 101, the shift amount of the image capturing apparatus 101, and the like are calculated.

An operation unit 210 is provided so that various operations are performed on the image capturing apparatus 101, and includes, for example, a power button, a button with which an imaging trigger is given to the image capturing apparatus 101, and the like. When the power button is operated, power is supplied to the image capturing apparatus 101, and the image capturing apparatus 101 is started. An audio inputting unit 213 uses a microphone provided in the image capturing apparatus 101 to collect audio signals around the image capturing apparatus 101 and transmits, to the audio processing unit 214, a digital audio signal acquired by analog-to-digital conversion. The audio processing unit 214 performs audio-related processing such as optimization processing on the received digital audio signal. The controlling unit 223 transmits, to the memory 215, the audio signal on which the audio processing unit 214 has performed various processes. The memory 215 temporarily stores image signals or audio signals acquired by the image processing unit 207 and the audio processing unit 214.

The image processing unit 207 generates a compressed image signal by reading the image signal temporarily stored in the memory 215 and performing encoding and the like on the image signal. The audio processing unit 214 generates a compressed audio signal by reading the audio signal temporarily stored in the memory 215 and performing encoding and the like on the audio signal. The controlling unit 223 transmits the compressed image signal and the compressed audio signal to the recording/reproducing unit 220.

The recording/reproducing unit 220 records, on a recording medium 221, the compressed image signal and the compressed audio signal respectively generated by the image processing unit 207 and the audio processing unit 214, other control data relating to imaging, or the like. In a case where the encoding and compressing are not performed on an audio signal, the controlling unit 223 transmits the audio signal generated by the audio processing unit 214 and the compressed image signal generated by the image processing unit 207 to the recording/reproducing unit 221 and cause the recording/reproducing unit 220 to record the audio signal and the compressed image signal.

The recording medium 221 is a recording medium (HD, etc.) in the image capturing apparatus 101 or a recording medium (USB memory, memory card, etc.) detachably attachable to the image capturing apparatus 101. The recording medium 221 can record various data such as compressed image signals, compressed audio signals, or audio signals generated by the image capturing apparatus 101, and generally has a larger capacity than the nonvolatile memory 216. Examples of the recording medium 221 include hard disks, optical disks, magneto-optical disks, CD-Rs, DVD-Rs, magnetic tapes, nonvolatile semiconductor memories, flash memories, and the like.

The recording/reproducing unit 220 has a function of reading and reproducing compressed image signals, compressed audio signals, audio signals, various data, or programs recorded on the recording medium 221. The controlling unit 223 transmits the compressed image signal and the compressed audio signal read by the recording/reproducing unit 220 to the image processing unit 207 and the audio processing unit 214. The image processing unit 207 and the audio processing unit 214 temporarily store the compressed image signal and the compressed audio signal in the memory 215, decode them according to a predetermined procedure, and transmit the decoded signals to the image outputting unit 217.

The audio outputting unit 218 includes a speaker in the image capturing apparatus 101 and outputs, for example, a preset audio pattern from the speaker in imaging. An LED controlling unit 224 includes a plurality of LEDs and controls lighting of the plurality of LEDs according to, for example, a set lighting/blinking pattern in imaging. The image outputting unit 217 includes, for example, an image outputting terminal and outputs an image signal so that the image is displayed on a connected external display or the like. The audio outputting unit 218 and the image outputting unit 217 may be one connected terminal. That is, they may be a high-definition multimedia interface (HDMI (registered trademark)) terminal or the like.

A communication unit 222 performs communication between the image capturing apparatus 101 and an external apparatus. The communication unit 222 transmits and receives data such as an audio signal, an image signal, a compressed audio signal, and a compressed image signal. The communication unit 222 also has a function of transmitting information on an internal state of the image capturing apparatus 101, such as error information, to the external apparatus in a case where the image capturing apparatus 101 detects an abnormal state. The communication unit 222 is, for example, an infrared communication module, a Bluetooth (registered trademark) communication module, a wireless LAN communication module, a wireless USB, or a wireless communication module such as a GPS receiver.

### Communication with External Apparatus

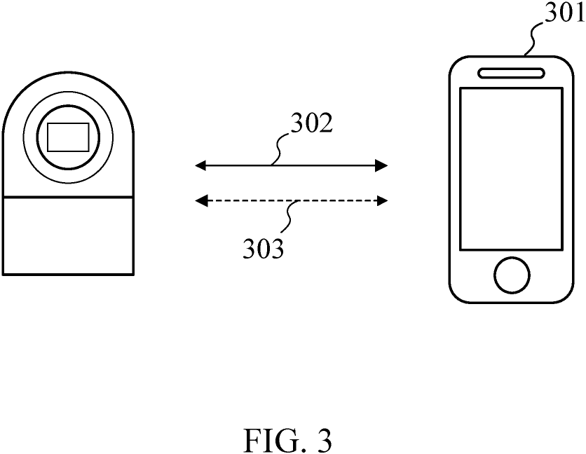

Next, with reference to FIG. 3, a description is given of communication between the image capturing apparatus 101 and the external apparatus 301. FIG. 3 is an explanatory diagram of communication between the image capturing apparatus 101 and the external apparatus 301.

The image capturing apparatus 101 is an apparatus having an imaging function, and the external apparatus 301 is a smart device including a Bluetooth (registered trademark) communication module, a wireless LAN communication module, or the like. The external apparatus 301 is, for example, a smartphone. The image capturing apparatus 101 and the external apparatus 301 can communicate with each other by first communication 302 and second communication 303. For example, the first communication 302 is wireless LAN communication conforming to “IEEE802.11” standard series, and the second communication 303 is communication including a master-slave relationship between a control station and a tributary station, such as Bluetooth (registered trademark) Low Energy (BLE).

The wireless LAN and BLE are examples of communication methods, and the image pickup apparatus 101 and the external apparatus 301 have functions to communicate in a plurality of types of communication methods. For example, another communication method may be used as long as a communication method used by one apparatus performing communication in the relationship between the control station and the tributary station can control a communication method of the other apparatus. However, without loss of generality, the first communication 302, such as wireless LAN, is capable of providing faster communication than the second communication 303, such as BLE. Furthermore, the second communication 303 has a feature of at least one of lower power consumption and a shorter communicable distance than the first communication 302.

### Tracking Operation Process

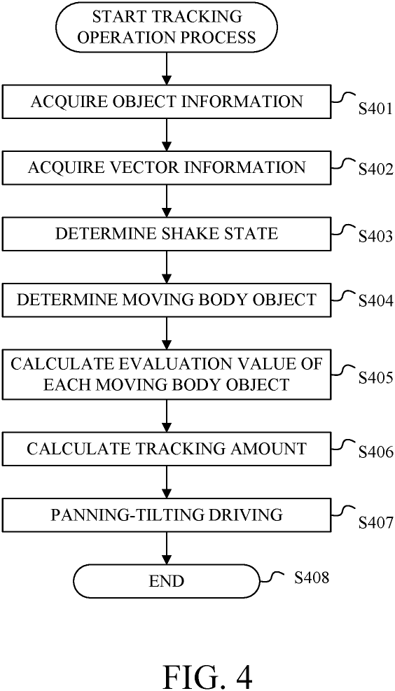

Next, with reference to FIG. 4, a description is given of an image capturing process (tracking operation process) according to this embodiment. FIG. 4 is a flowchart illustrating the tracking operation process (object tracking control) according to this embodiment. Each step in FIG. 4 is mainly executed by the image processing unit 207 or the controlling unit 223.

First, in step S401, the image processing unit 207 generates, from an image capturing signal captured by the image capturing unit 206, an image on which image processing for object detection has been performed. By using the generated image, “object detection” such as detection of a person and a thing is performed. In a case where a person is to be detected, a face or a body of the object is detected. In the “face detection process”, a pattern for a person’s face determination is preset and it is possible to detect a portion of the captured image that matches the preset pattern as a person’s face image.

At the same time, the image processing unit 207 calculates a “reliability” representing a probability that the object is a face. The “reliability” is calculated from, for example, a size of a “face area” in the image, a degree of matching with the face pattern, or the like. In thing recognition as well, a thing can be similarly recognized by determining whether or not its image matches a preset pattern. By calculating an “evaluation value” for each image area of the recognized object, the image area of the object with the highest “evaluation value” can be determined as a “main object area (specific object)”.

Subsequently, in step S402, the controlling unit 223 uses the shake detector 209 to acquire angular velocity outputs in the three axes from the angular speedometer 106 set in the fixed unit 103. The controlling unit 223 acquires the current panning and tilting angular positions from outputs from an encoder that is installed in each of the tilting rotating unit 104 and the panning rotating unit 105 and is capable of acquiring a rotation angle. The controlling unit 223 also acquires a “motion vector” (acquires vector information) calculated (detected) by the image processing unit 207. As a “motion vector” detection method, the image processing unit 207 first divides an image (image based on image data output from the image capturing unit 206) into a plurality of areas. Then, the image processing unit 207 compares a pre-stored image of one frame before the current frame and the current image (two consecutive images), and calculates a motion amount in the images based on relative shift information of the images. After the “motion vector” is acquired, the process proceeds to step S403.

Subsequently, in step S403, the controlling unit 223 determines a shake state of the image capturing apparatus 101 based on the angular velocities in the three axes output from the angular speedometer 106 set in the fixed unit 103. For example, it is possible to count the number of times the output from the angular speedometer 106 exceeds a threshold value Thresh1 during a predetermined period TIMEA, and determine that the shake amount is large if the counted value exceeds a threshold value Thresh2. Alternatively, threshold values may be set in stages, and the shake state may be determined in stages according to the magnitude of the shake amount. Alternatively, the shake amount may be calculated by filtering. For example, a method may be used that removes offset from the output from the angular speedometer 106 by cutting a low-frequency bandwidth with a high-pass filter (HPF), converts the HPF angular velocity into an absolute value, makes the converted signal pass through a low-pass filter (LPF), and calculates the signal having passed through the LPF as a shake level amount. By any of the above methods, it is possible to determine whether the shake of the image capturing apparatus 101 is in a large state or a small state. If the shake state is determined, the process proceeds to step S404.

### Moving Body Object Determination Method

Subsequently, in step S404, the object detector 225 in the controlling unit 223 determines whether or not there is a “moving body object detection area” on the captured image based on each piece of information acquired in step S402 (moving body object determination). Here, a description is given of the moving body object determination. First, the controlling unit 223 determines whether or not each image frame from the image processing unit 207 includes an object having a salient feature (salient object). In this embodiment, “saliency” is a degree of how salient a feature is, and the “saliency” is determined based on hue, saturation, and brightness.

It is assumed that the more conspicuous a distinction from the background is, the higher the “saliency” is. A method for calculating the “saliency” is disclosed in, for example, Laurent Itti, Christof Koch, and Ernst Niebur, “A Model of Saliency-Based Visual Attention for Rapid Scene Analysis”, IEEE Transactions on Pattern Analysis and Machine Intelligence archive Volume 20 Issue 11, November 1998 Pages 1254-1259 (hereinafter referred to as “Laurent”). The “saliency” can be calculated using the known saliency calculation method disclosed in Laurent.

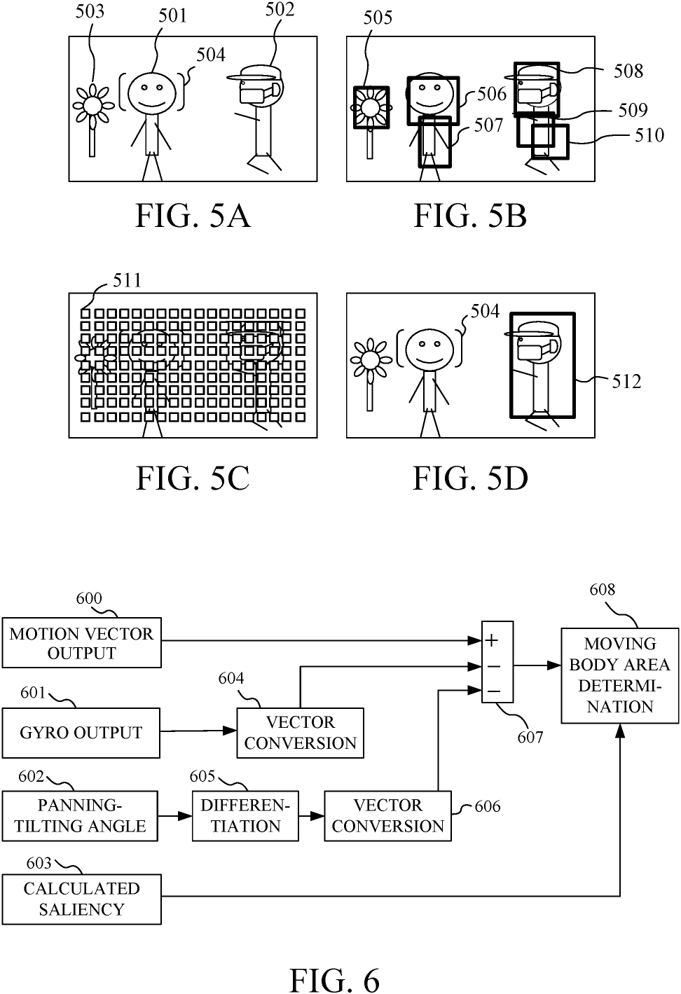

In this embodiment, the controlling unit 223 determines whether or not there is a “moving body object detection area” based on the “salient object” in the image frame and a “motion vector detection position” in the image (moving body object detection process). The moving body object detection process is described with reference to FIGS. 5A to 5D and FIG. 6. FIGS. 5A to 5D and FIG. 6 are explanatory diagrams of the moving body object detection process.

In FIG. 5A, a reference numeral 501 denotes a “still person”. An area denoted by a reference numeral 504 is an object whose face can be detected. A reference numeral 502 is an object whose face is hidden and cannot be detected, and is an object whose image changes greatly between frames as it moves. A reference numeral 503 is an object in an area in which features, such as hue, saturation, and brightness, are salient as an image, and is an object which hardly moves.

Reference numerals 505 to 510 in FIG. 5B denote results of the extraction of “saliency calculation areas” for calculating “saliencies” by the method described above. A “motion vector” is detected as a pixel moving amount of a difference between image frames of an area that is provided at a specific position of an image as indicated by a reference numeral 511 in FIG. 5C. The detection positions of the “motion vector” cover the entire image so that the “motion vector” can be detected. Among the “saliency calculation areas (reference numerals 505 to 510)”, a “saliency calculation area” in which the number of vectors whose moving amount of the “motion vector” is equal to or larger than a “threshold value 1” is detected is equal to or larger than a “threshold value 2” is determined as a “moving body object detection area”.

A description is given of a case where, as indicated by the reference numerals 508 to 510, the “saliency calculation areas” overlap or are very close to each other and a “moving body object” is detected in each “saliency calculation area”. The “moving body object detection areas” are determined as one area (denoted by a reference numeral 512) in FIG. 5D. Here, the object (reference numeral 501) and the object (reference numeral 503) do not move in the image frame. Therefore, the detected amounts of the “motion vectors” in the “saliency calculation areas” denoted by the reference numerals 505, 506, and 507 are very small values, and they are not determined as “moving body object detection areas”. In the “saliency calculation areas” denoted by the reference numerals 508, 509, and 510, the number of vectors whose moving amount of the “motion vector” is equal to or larger than the “threshold value 1” is detected to be equal to or larger than the “threshold value 2”, and the “saliency calculation areas” denoted by the reference numerals 508, 509, and 510 are determined as “moving body object detection areas”. Also, as indicated by the reference numerals 508, 509, and 510, the “saliency calculation areas” overlap, and they are determined as one “moving body object detection area”. As a result, it is determined that there is one “moving body object detection area” (reference numeral 512).

In this embodiment, as illustrated in FIGS. 1A to 1D, the image capturing apparatus 101 includes a panning-tilting mechanism. During “object tracking” by panning or tilting, even when the object does not move, a movement on the image capturing plane is caused by panning or tilting driving. As a result, an output value at the detection position of each “motion vector” becomes large. In addition, when an image is captured while the image capturing apparatus 101 is held by hand and moved, image blur is caused by a camera shake. As a result, even in a case where there is no actual movement of the object, a movement occurs on the image capturing plane, and the output value at the detection position of each “motion vector” becomes large. Therefore, in this embodiment, by a method illustrated in FIG. 6, an amount of “motion vector” from which the image blur caused by panning or tilting driving or the camera shake is removed is calculated, and then it is determined whether or not there is a “moving body object detection area” (moving body object detection process). A description thereof is given with reference to FIG. 6.

A gyro output 601, which is an output from the gyro, is multiplied by a conversion gain for converting the “angular velocity” into an “image plane blur pixel” so that the system of units is matched with the motion vector output 600 (vector conversion 604). On a panning-tilting angle 602, a differentiation 605 is performed so that a “panning-tilting angular velocity” is acquired. Thereafter, the “panning-tilting angular velocity” is multiplied by a conversion gain for converting the “panning-tilting angular velocity” into an “image plane blur pixel” (vector conversion 606). That is, the “panning-tilting angular velocity” and the gyro angular velocity (gyro output 601) are converted into axial blur components on the image capturing plane based on the panning-tilting angle, and then “blur angular velocities” defined by a vertical axis and a horizontal axis on the image capturing plane is calculated. An adding-subtracting portion 607 subtracts, from the respective motion vector output results, the gyro output 601 having been converted into the vector and the panning-tilting angular velocity having been converted into the vector, and inputs the calculation result to a moving body area determination 608. On the other hand, a “calculated saliency” 603 calculated for the “saliency calculation area” is also input to the moving body area determination 608. Then, whether or not there is a “moving body object detection area” is determined by the method described with reference to FIGS. 5A to 5D.

Also, from each “motion vector” in the “moving body object detection area”, a moving amount of the “motion vector” in the “moving body object detection area” and its “reliability” are calculated. For all the “motion vectors” detected in the “moving body object detection area”, the range of values of the “motion vectors” is divided into several intervals. Then, a “frequency distribution process” is performed for arranging the frequency of detection of the values of the “motion vectors” included in each section.

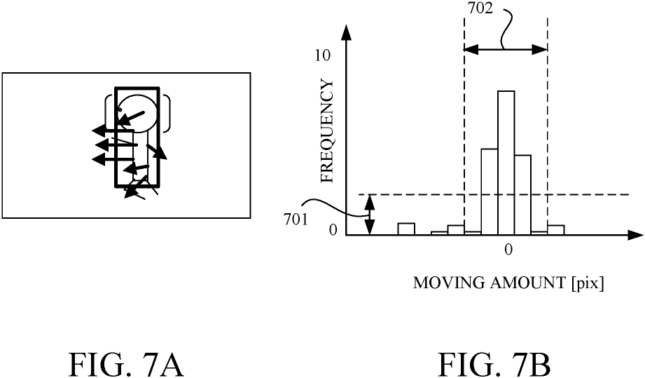

With reference to FIGS. 7A and 7B, a description is given of the “frequency distribution process”. FIGS. 7A and 7B are explanatory diagrams of the frequency distribution process. FIG. 7A illustrates an example of detected “motion vectors” in a “moving body object detection area”. In FIG. 7B, a horizontal axis represents “moving amount (pixels)” and a vertical axis represents “frequency”. In the histogram, among moving amounts of which the number of detections (frequency) of the “motion vectors” is equal to or larger than a threshold value denoted by a reference numeral 701, the “moving body object detection area” is set to a section 702 where such moving amounts are concentrated. Based on an average value of the moving amounts of the “motion vectors” in the set “moving body object detection area” (section 702), a “representative motion vector amount” of the “moving body object” is calculated. Furthermore, a reliability of the moving amount of the “representative motion vector” is calculated from a variance of the moving amounts of all the “motion vectors” in the “moving body object detection area”. Here, in a case where the variance is large, the “reliability” is determined to be low, and in a case where the variance is small, the “reliability” is determined to be high.

With reference to FIG. 6, a description is given above of a method for determining the moving body area by subtracting, from the motion vector output 600, the shake of the image capturing apparatus 101 (camera shake) and the motion of the image capturing apparatus 101 caused by panning-tilting driving (camera motion vector). In this regard, there is a problem that the output value of the camera motion vector caused by the camera shake or the panning-tilting driving varies depending on a distance from the image capturing apparatus 101 to the object.

FIGS. 9A to 9C are explanatory diagrams of operation of the image capturing apparatus 101. FIG. 9A illustrates a rotation direction of the image capturing apparatus 101. FIG. 9B illustrates motion vectors calculated by the image processing unit 207 of the image capturing apparatus 101. FIG. 9C illustrates a vector quantity acquired by subtracting the camera motion vector from the motion vector.

Based on a parallel shake Y at a principal point position of the image capturing optical system, a shake angle θ of the image capturing optical system, a focal length f of the image capturing optical system, and an imaging magnification β, blur δ occurring on the image capturing plane is calculated by the following equation (1).

$$\text{δ} \text{=} \left(\text{1+} \text{β}\right) \text{f} \text{θ} \text{+} \text{β} \text{Y}$$

As expressed by the equation (1), the blur δ occurring on the image capturing plane varies depending on the focal length f and the imaging magnification β. A focal length can be calculated from information on the imaging optical system, but the imaging magnification β differs for each object. Regarding an object 901 standing still at a far distance and an object 902 standing still at a short distance on the image, output values are such that a vector quantity 903 in an area of the object 902 is larger than a vector quantity 904 in an area of the object 901. Thus, there is a problem that a still object at a close distance may be erroneously detected as a moving body object (vector quantity 904) due to the variation in an output value of a vector of a still object depending on a distance between the image capturing apparatus 101 and the object.

Therefore, the determination threshold value for the moving body object determination is varied depending on the result of the shake state determination in step S403 in FIG. 4 or on the panning-tilting angular velocity (output of the differentiation 605 in FIG. 6). If the number of vectors whose moving amount of the “motion vectors” are equal to or larger than the “threshold value 1” is detected to be equal to or larger than the “threshold value 2”, the area is determined as a “moving body object detection area”. However, for example, if the result of shake state determination is “large shake”, the “threshold value 1” or the “threshold value 2” is set to be small so that the object is less likely to be determined as a moving body object. If the result of the shake state determination is “small shake”, the “threshold value 1” or the “threshold value 2” is set to be large so that determination that the object is a moving body object is less likely to be made. If the panning-tilting angular velocity is large, the “threshold value 1” or the “threshold value 2” is set to be small so that the object is less likely to be determined as a moving body object. Furthermore, if the panning-tilting angular velocity is small, the “threshold value 1” or the “threshold value 2” is set to be large so that the object is less likely to be determined as a moving body object. Such a method can hinder the problem of erroneously detecting a still object at a close distance as a moving body object.

There is also a method of acquiring distance information (depth information) from a plurality of pieces of image data from different viewpoints by using an image capturing plane phase difference detection method using a split-pupil image sensor. From a plurality of images acquired in this case, it is possible to generate an image shift amount map, a defocus amount map of defocus amounts calculated by multiplying image shift amounts by a predetermined conversion coefficient, a distance map of distances acquired by converting the defocus amounts into object distance information, and distance images. The camera motion vectors may be calculated by using β calculated for each image position based on the distance map acquired as described above.

However, calculation errors may make it difficult to accurately calculate β. In that case, after subtraction is performed by using a camera motion vector that is calculated while β based on the distance map is taken into account, erroneous detection of a moving body object is hindered by varying the “threshold value 1” or the “threshold value 2” depending on the result of the shake state determination and the panning-tilting velocity.

### Calculation Method of Tracking Evaluation Value of Moving Body Object

Subsequently, in step S405 of FIG. 4, the controlling unit 223 calculates an evaluation value (evaluation value information) for tracking control for each moving body object detected in step S404. Subsequently, in step S406, based on information on a position on the image of each moving body object detected in step S404 and the evaluation value information of each moving body object calculated in step S405, the controlling unit 223 calculates a center-of-gravity position of the moving body objects. The controlling unit 223 then calculates a tracking amount for instructing the panning-tilting driving unit 205 to shift the center-of-gravity position to a tracking target position (for example, the center of the image).

Subsequently, in step S407, the controlling unit 223 performs tracking control for the moving body object by driving the panning-tilting driving unit 205 based on the tracking amount detected in step S406. Subsequently, in step S408, the controlling unit 223 ends this process and enters a wait state for waiting for this process to be executed in a next image capturing cycle.

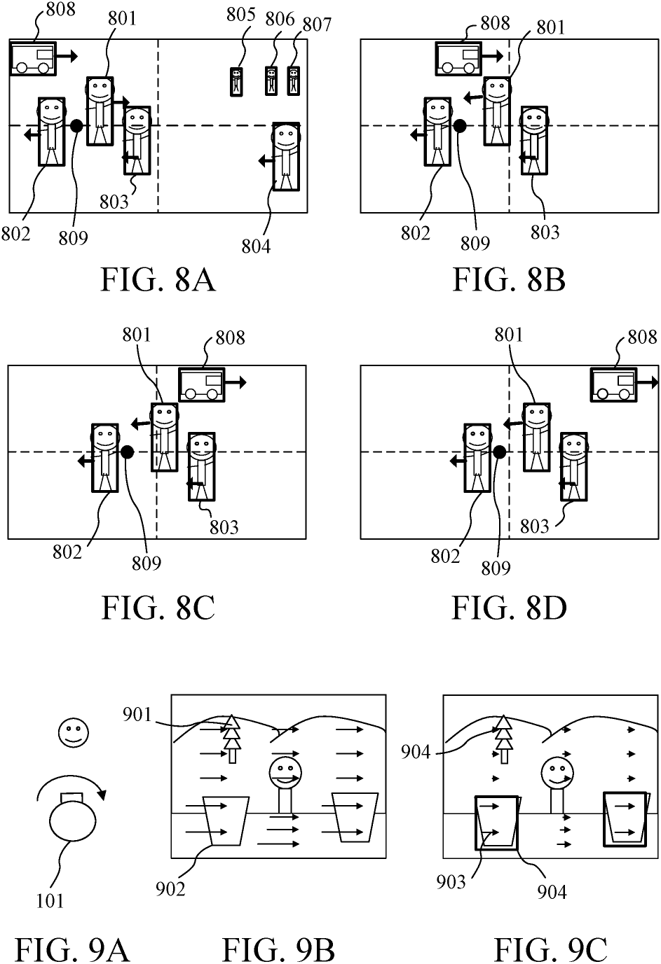

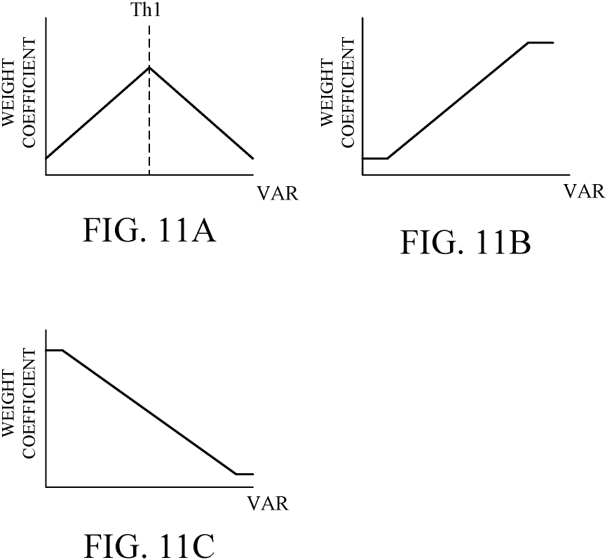

With reference to FIGS. 8A to 8D and FIGS. 11A to 11C, a detailed description is given of the calculation of the evaluation value of each moving body object, the calculation of the tracking amount, and the tracking control in steps S405, S406, and S407 in the tracking operation process. FIGS. 8A to 8D are explanatory diagrams of the tracking operation process. FIGS. 11A to 11C are examples of weight calculation tables.

The following information is acquired for each of detected moving body objects 801 to 808.

(1) Object Size: The size of the moving body object is calculated by the method described with reference to FIGS. 5A to 5D, and the size is acquired as additional information for each moving body object. A weight calculation table as illustrated in FIG. 11A is stored such that a weight coefficient is the largest when the object size is equal to a threshold value Th1, the weight coefficient is small when the object size is smaller than the threshold value Th1, and the weight coefficient is small when the object size is larger than the threshold value Th1.

(2) Magnitude of Velocity of Object: A magnitude of the velocity of the moving body object is calculated by the method described with reference to FIGS. 7A and 7B, and the magnitude is acquired as additional information for each moving body object. A weight calculation table as illustrated in FIG. 11A is stored such that a weight coefficient is the largest when the magnitude of the velocity of the object is equal to a threshold value Th1, the weight coefficient is small when the magnitude is smaller than the threshold value Th1, and the weight coefficient is small when the magnitude is larger than the threshold value Th1.

(3) Moving Direction of Object: A moving direction of the moving body object is calculated by the method described with reference to FIGS. 7A and 7B, and the moving direction is acquired as additional information for each moving body object. Furthermore, whether the object is moving away from the center of the image or moving toward the center of the image is calculated. When the object is moving away from the center of the image, the weight coefficient is increased, and when the object is moving toward the center of the image, the weight coefficient is calculated so that the weight coefficient decreases.

(4) Number of Detected Vectors: The number of valid vectors (the number of detected vectors) in the detected moving body object is calculated by the method described with reference to FIGS. 7A and 7B, and the number of vectors is acquired as additional information for each moving body object. Alternatively, a ratio of the valid vectors to the total number of vectors in the moving body object may be acquired. A weight calculation table as illustrated in FIG. 11B is stored such that the larger the number of vectors, the larger the weight coefficient.

(5) Detected Vector Variance: Variance of the vectors in the detected moving body object is calculated by the method described with reference to FIGS. 7A and 7B, and the variance is acquired as additional information for each moving body object. A weight calculation table as illustrated in FIG. 11C is stored such that the larger the vector variance, the smaller the weight coefficient.

(6) Detection Information of Specific Object around Moving Body Object: If a specific object is detected inside or near the detected moving body object, the detection information thereof is acquired as additional information for each moving body object. The weight coefficient is calculated so that the weight is increased if the specific object is detected, and the weight is decreased if the specific object is not detected.

A final weight coefficient of each moving body object is calculated from the weight coefficients calculated in (1) to (6) described above. The final weight coefficient may be calculated by adding the weight coefficients of (1) to (6), or may be further multiplied by a coefficient according to a degree of importance.

A description is given of a case in which moving body objects 801 to 808 are detected in FIG. 8A as an example. The sizes of the moving body objects 802 and 803 are large and the moving body objects 802 and 803 move away from the center of the image, and therefore large weight coefficients are acquired. If the number of valid vectors is large, if the vector variance is small, or if a specific object (person) is detected, each weight coefficient is set even higher. The sizes of the moving body objects 801 and 804 are large, but even in a case where their weight coefficients of the other items are determined to be large, the weight coefficients are set to be small because they move to the center of the image. The moving body object 808 also moves to the center of the image, and therefore its weight coefficient is set to be small. The moving body objects 805, 806, and 807 are small and their numbers of vectors are small, and therefore the weight coefficients thereof are set to be small.

A center-of-gravity position 809 (H) of the moving body objects is calculated from a weight coefficient x and an object position y of each moving body obj ect.

$$\text{H =} \frac{{\sum }_{\text{i}}^{\text{N}} {\text{x}}_{\text{i}} {\text{y}}_{\text{i}}}{{\sum }_{\text{i}}^{\text{N}} {\text{x}}_{\text{i}}}$$

A tracking amount is calculated that is used in instructing the panning-tilting driving unit 205 to shift the center-of-gravity position to the tracking target position (for example, the center of the image). If the tracking amount is too large, the angle of view may be conspicuously fluctuated by sharp changes in the image, and control oscillation may be caused by an effect of a delay in image detection or mechanical driving. Therefore, a tracking amount is calculated that gradually shifts the center-of-gravity position to the center of the image. Based on the calculated tracking amount, the panning-tilting driving unit 205 is driven and tracking control is performed for the moving body objects.

In FIG. 8B illustrating the next frame of FIG. 8A, tracking control is performed from calculation of the center-of-gravity position. The weight of the moving body object 808 is set small because the moving body object 808 moves in a direction approaching the center of the image.

In FIGS. 8C and 8D illustrating further next frames, the moving body object 808 moves away from the center of the image, but it moves in a same direction from FIG. 8A to FIGS. 8C and 8D. Objects such as cars passing through the background mostly move in one direction. Therefore, in order that the moving body object 808 is determined to be a background moving object, in a case where it is detected that a moving body object moving from an edge of the image in a direction toward the center of the image as illustrated in FIG. 8A continues to move in a certain direction until the moving body object reaches the center of the image, the moving body object 808 is determined as the background object. The moving body object 808 is detected by determining whether or not a moving body object and the moving body object 808 are the same moving body object, and this determination is made by predicting the movement of the moving body object 808 in the next frame based on the direction and velocity of the movement of the moving body object 808 and determining that a moving body object detected in the predicted area is the moving body object 808. If the moving body object 808 is determined to be the background moving object when the moving body object 808 reaches the center of the image, the weight of the moving body object 808 is set to be small so that the movement of the moving body object 808 does not affect the tracking.

By the above-described method, the weight coefficient corresponding to the evaluation value of each moving body object is calculated for each detected moving body object. Then, by tracking the moving body object based on the weight coefficients and the center-of-gravity position of the moving body objects, automatic tracking control can be performed mainly for an object within the angle of view among a plurality of moving body objects including objects erroneously detected as a moving body.

In this embodiment, a description is given of the method of calculating the tracking amount by calculating the center-of-gravity position of the moving body objects from the positions and weight coefficients of the moving body objects, but the method is not limited to this. A method may be used in which, for each moving body object, a target tracking amount z is calculated based on a position of the moving body object, and a final tracking amount C of the moving body objects is calculated from weight coefficients x calculated by a method similar to the method described above and the target tracking amounts z.

$$\text{C =} \frac{{\sum }_{\text{i}}^{\text{N}} {\text{x}}_{\text{i}} {\text{z}}_{\text{i}}}{{\sum }_{\text{i}}^{\text{N}} {\text{x}}_{\text{i}}}$$

According to the result of the shake state determination in step S403 or the panning-tilting angular velocity (output of differentiation 605), the tracking control amount is multiplied by a coefficient ks so that the panning-tilting tracking control amount is varied. If the result of the shake state determination is “large shake”, the coefficient ks is set to be small so that the panning-tilting tracking control amount is small. If the result of the shake state determination is “small shake”, the coefficient ks is set to be large so that the panning-tilting tracking control amount is large. If the panning-tilting angular velocity is large, the coefficient ks is set to be small so that the panning-tilting tracking control amount is small. If the panning-tilting angular velocity is small, the coefficient ks is set to be large so that the panning-tilting tracking control amount is large. In this way, in a case where a still object at a close distance is erroneously detected as a moving body object, the tracking control amount is reduced, and thereby it is possible to reduce a variation in the angle of view caused by the erroneous moving body detection and erroneous tracking.

As described above, in this embodiment, the image capturing apparatus 101 includes the image capturing unit 206, the motion vector detector (image processing unit 207), the object detector 225, the driving unit (panning-tilting driving unit 205), and the controlling unit 223. The motion vector detector detects motion vectors based on image data output from the image capturing unit. The object detector detects a plurality of moving objects based on the motion vectors. The driving unit drives the image capturing unit, and the controlling unit performs tracking control (object tracking control) by controlling the driving unit. The controlling unit calculates evaluation values of the plurality of moving objects based on at least one of information on the plurality of moving objects, information on a shake of the image capturing apparatus, and information on a driving state of the driving unit, and controls the driving unit based on the evaluation values.

The evaluation values may be weight coefficients of the plurality of moving objects. The controlling unit calculates a center-of-gravity position of the plurality of moving objects based on the positions and the weight coefficients of the plurality of moving objects, and controls the driving unit based on the center-of-gravity position. The object detector may detect the plurality of moving objects based on vectors acquired by calculating a shake vector of the image capturing unit based on the information on the driving state of the driving unit and the information on a shake of the image capturing apparatus and subtracting the shake vector from the motion vectors. The controlling unit may calculate the evaluation values based on at least one of the sizes, velocities, moving directions, the numbers of detected vectors, and variances of the detected vectors of the plurality of moving objects, and the detection information of a specific object near the plurality of moving objects.

The controlling unit may set an evaluation value to a first evaluation value if the shake amount of the image capturing apparatus is a first shake amount, and may set the evaluation value to a second evaluation value smaller than the first evaluation value if the shake amount is a second shake amount larger than the first shake amount. The object detector may set a detection condition of each of the plurality of moving objects to a first condition if the shake amount of the image capturing apparatus is the first shake amount, and may set the detection condition to a second condition which is a more limited condition than the first condition if the shake amount is the second shake amount larger than the first shake amount. The controlling unit may set a tracking amount in tracking control to a first tracking amount if the shake amount of the image capturing apparatus is the first shake amount, and may set the tracking amount to a second tracking amount smaller than the first tracking amount if the shake amount is a second shake amount larger than the first shake amount.

The controlling unit may set an evaluation value to the first evaluation value if the velocity of the driving unit is the first velocity, and may set the evaluation value to the second evaluation value smaller than the first evaluation value if the velocity is the second velocity higher than the first velocity. The object detector may set the detection condition of each of the plurality of moving objects to the first condition if the velocity of the driving unit is the first velocity, and may set the detection condition to the second condition which is a more limited condition than the first condition if the velocity is the second velocity faster than the first velocity. The controlling unit may set the tracking amount in the tracking control to the first tracking amount if the velocity of the driving unit is the first velocity, and may set the tracking amount to the second tracking amount smaller than the first tracking amount if the velocity is the second velocity higher than the first velocity. The controlling unit may perform tracking control during motion imaging.

According to this embodiment, it is possible to provide an image capturing apparatus that can perform control suitable for imaging a plurality of moving objects.

### Second Embodiment

Next, a description is given of the second embodiment of the present disclosure. In the first embodiment, a description is given of the method of the panning-tilting tracking control for a plurality of moving body objects. On the other hand, this embodiment describes a method for solving a problem of a case where erroneous detection or erroneous tracking of a moving body object causes an image capturing angle of view to face an unintended direction, and thereafter an object to be imaged does not appear in the angle of view.

### Image Capturing Process

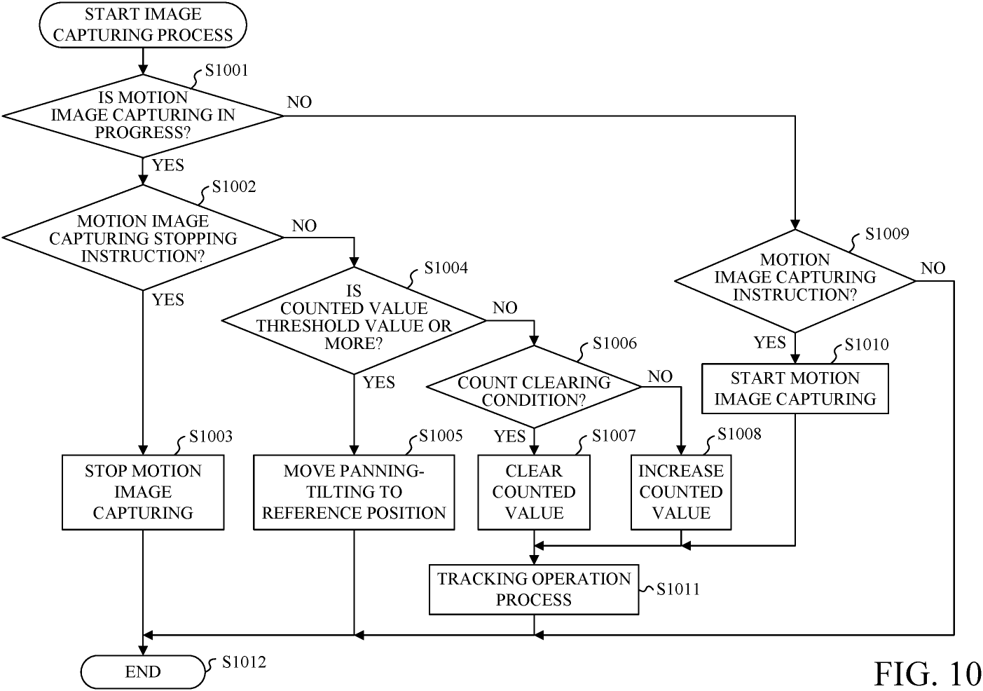

With reference to FIG. 10, a description is given of an “image capturing process” and a “tracking operation process”. FIG. 10 is a flowchart illustrating the image capturing process according to this embodiment.

First, in step S1001, the controlling unit 223 determines whether or not motion image capturing is in progress. If motion image capturing is not in progress (NO), the process proceeds to step S1009, and the controlling unit 223 determines whether or not a motion image capturing instruction is given. If it is determined in step S1009 that the motion image capturing instruction is given (NO), the process proceeds to step S1012, and the controlling unit 223 ends this process and enters a wait state for waiting for execution of this process in the next image capturing cycle. On the other hand, if it is determined in step S1009 that the motion image capturing instruction is given (YES), the process proceeds to step S1010, the controlling unit 223 starts motion image capturing, the process proceeds to step S1011, and the tracking operation process is performed as described with reference to FIG. 4. After the tracking operation process, the process proceeds to step S1012, and the controlling unit 223 ends this process and enters the wait state for waiting for execution of this process in the next image capturing cycle.

If it is determined in step S1001 that motion image capturing is in progress (YES), the process proceeds to step S1002, and the controlling unit 223 determines whether or not a motion image capturing stopping instruction is given. If the motion image capturing stopping instruction is given (YES), the process proceeds to step S1003, and the controlling unit 223 stops the motion image capturing. Then, in step S1012, the controlling unit 223 ends this process and enters the wait state for waiting for execution of this process in the next image capturing cycle.

Here, a description is given of methods of the motion image capturing instruction in step S1009 and the motion image capturing stopping instruction in step S1002. An instruction for starting/stopping motion image capturing may be given by a user’s operation such as pressing a shutter button provided on the image capturing apparatus 101, tapping the image capturing apparatus 101 with a finger or the like, inputting an audio command, and issuing an instruction from the external apparatus 301. Alternatively, an instruction for starting/stopping motion image capturing is given by an automatic imaging determination process that automatically determines a time of starting/stopping motion image capturing.

In automatic imaging determination, it is determined whether or not automatic imaging is to be performed based on a detected object. For example, motion image capturing may be started in a case where a specific person object is detected and its facial expression and pose satisfy a predetermined condition, and the motion image capturing may be stopped in a case where the specific person object disappears. Alternatively, motion image capturing may be started at a time when a moving body object is detected, and the motion image capturing may be stopped in a case where a period in which the moving body object cannot be detected continues.

If a motion image capturing stopping instruction is not given and motion image capturing is continued (NO) in step S1002, the process proceeds to step S1004. In step S1004, the controlling unit 223 determines whether or not a counted value of a counter provided for returning a panning-tilting position (a position of the panning-tilting unit, that is, a position of the image capturing unit 206) to a reference position is equal to or larger than a threshold value ThC. If the counted value of the counter is equal to or larger than the threshold value ThC (YES), the process proceeds to step S1005. In step S1005, the controlling unit 223 moves the panning-tilting position to the reference position. Subsequently, in step S1012, the controlling unit 223 ends this process and enters the wait state for waiting for execution of this process in the next image capturing cycle. On the other hand, if the counted value of the counter is smaller than the threshold value ThC in step S1004, the process proceeds to step S1006.

In step S1006, the controlling unit 223 determines whether or not a count clearing condition is satisfied. If the count clearing condition is satisfied (YES), the process proceeds to step S1007. In step S1007, the controlling unit 223 clears the counted value of the counter to zero. Subsequently, in step S1011, the controlling unit 223 performs a tracking operation process. On the other hand, if the count clearing condition is not satisfied (NO) in step S1006, the process proceeds to step S1008. In step S1008, the controlling unit 223 increases the counted value of the counter. Subsequently, in step S1011, the controlling unit 223 performs the tracking operation process. After the controlling unit 223 performs the tracking operation process in step S1011, the process proceeds to step S1012, and the controlling unit 223 ends this process and enters the wait state for waiting for execution of this process in the next image capturing cycle.

Next, a description is given of a method for determining the count clearing condition in step S1006 and a method for increasing (counting up) the counted value in step S1008.

### Method for Setting Reference Position

The reference position for a panning-tilting angle (panning-tilting position) is set in advance before the motion image capturing starts. Any of the methods described below may be used to set the reference position.

A description is given of a first method for setting the reference position to a panning-tilting position at the start of the motion image capturing. In a case where the user manually provides an instruction for starting imaging as the motion image capturing instruction in step S1009, the user can provide the instruction for imaging after checking whether or not the lens barrel 102 of the image capturing apparatus 101 faces a direction in which the user wants to capture an image. Therefore, there is a high possibility that an imaged object appears at the panning-tilting position at a time when the motion image is started. In a case where the motion image capturing starting instruction is given by the automatic image capturing process, the automatic motion image capturing is performed at a time when the object to be imaged is detected. Hence, there is a high possibility that an imaged object appears at the panning-tilting position at a time when the motion image is started. Therefore, the reference position is set to the panning-tilting position when the motion image capturing is started.

Alternatively, there is a method in which the user sets the reference position. For example, after moving, with a user’s operation, the panning-tilting position to a panning-tilting position to be set as the reference position by using a dedicated application provided in the external apparatus 301 while checking an image from the image capturing apparatus 101, the user can set the reference position to the panning-tilting position. A method may be used of setting the reference position to a panning-tilting position when a specific command of an audio command is detected, and a method may be used in which the user rotates the panning-tilting unit by hand and sets the reference position to a position where the user stops the rotation. In any of the methods, the reference position can be set by the user’s operation.

### Method for Counting Up Counted Value

Next, a description is given of a method of increasing (counting up of) the counted value in step S1008. A count-up value COUNT can be varied as expressed by the following equation (4) based on a time during which a rotational position of the panning-tilting unit (the position of the image capturing unit 206) is away from the reference position, and an angular amount between the rotational amount and the reference position, the detection information acquired by the moving body detector, the detection information of the specific object, or the like.

$$\text{COUNT = K1×K2×K3×K4×Base}$$

K1 is a coefficient that varies depending on an elapsed time after the rotational position of the panning-tilting unit leaves the reference position. A value of K1 is set to be increased as the elapsed time after the rotational position of the panning-tilting unit passes through the reference position increases. K2 is a coefficient that varies depending on the angular amount by which rotational position of the panning-tilting unit is away from the reference position. The value of K2 is set to be increased as the angular amount by which the rotational position of the panning-tilting unit is away from the reference position increases. K3 is a coefficient that varies depending on whether or not a moving body object is detected. The value of K3 is set to be small during a period in which a moving body object is detected, and to be large during a period in which a moving body object is not detected. K4 is a coefficient that varies depending on whether or not a specific object is detected. The value of K4 is set to be small during a period in which a specific object is detected, and to be large during a period in which a specific object is not detected. Base is a fixed parameter of a minimum counted value, and the coefficients K1 to K4 are variable and are numerical values of 1 or more.

As described above, the longer the elapsed time since the rotational position of the panning-tilting unit passed the reference position and the greater the angular amount by which the rotational position of the panning-tilting unit is away from the reference position, the larger the count-up value of the counted value. This makes it easy to return the rotational position to the reference position. Furthermore, if a moving body object or a specific object is not detected, the count-up value of the counted value is increased so that the rotational position is likely to return to the reference position.

In this embodiment, the count-up value does not need to be based on all of the time during which the position of the image capturing unit 206 is away from the reference position, the angular amount by which the position of the image capturing unit 206 is away from the reference position, the detection information of the moving object, and the detection information of the specific object (that is, not all of the coefficients K1 to K4 do not need to be variables). For example, the count-up value COUNT may be set based on at least two of them (at least two of the coefficients K1 to K4 may be variable).

### Count Clearing Condition Determination

Next, a description is given of the method of clearing the count in step S1007. If the rotational position of the panning-tilting unit passes the reference position, the counted value is cleared to 0. Alternatively, the counted value may be cleared to 0 if a specific object is detected, if a moving body object of a specific condition is detected, or depending on a condition of a specific object or a moving body object. For example, the counted value may be cleared if a specific object having been detected at the start of the automatic motion image capturing is detected, or the counted value may be cleared at the time at which the specific object set by the user in advance via a dedicated application provided in the external apparatus 301 is detected. Furthermore, the counted value may be cleared if a plurality of moving body objects are detected, or the counted value may be cleared if a specific object is detected and a moving body object is detected near the specific object.

As described above, in this embodiment, the object detector 225 detects a moving object based on a motion vector or a specific object, and the controlling unit 223 sets the reference position for the image capturing unit 206. The controlling unit determines whether or not to move the image capturing unit to the reference position, based on at least two of the time during which the position of the image capturing unit is away from the reference position, the angular amount by which the position of the image capturing unit is away from the reference position, the detection information of the moving object, and the detection information of the specific object. The reference position may be set by a user’s instruction. The reference position may be a position at which motion image capturing is started.

According to this embodiment, in a case where erroneous detection or erroneous tracking of a moving body object moves an image capturing angle of view to a position far away from a reference position and thereafter an object to be imaged does not appear in the angle of view, a panning-tilting position is returned to the reference position under a predetermined condition. This can increase a probability that the object to be imaged will become detectable again after the panning-tilting position returns to the reference position. In this embodiment, a description is given of an example of detecting a “moving body object” based on a captured image, but this embodiment is also applicable in a case of using a mechanism for detecting motion around the image capturing apparatus 101 by using infrared rays, ultrasonic waves, visible light, etc.

### Other Embodiment

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Each embodiment provides an image capturing apparatus that can perform control suitable for imaging of a plurality of moving objects, a control method of the image capturing apparatus, and a memory medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022- 022412, filed on Feb. 16, 2022, which is hereby incorporated by reference herein in its entirety.

What is claimed is:

1. An image capturing apparatus comprising:
an image capturing unit;
a driving unit configured to drive the image capturing unit; and
at least one processor configured to function as:
a motion vector detector configured to detect motion vectors based on image data output from the image capturing unit;
an object detector configured to detect a plurality of moving objects based on the motion vectors; and
a controlling unit configured to perform tracking control by controlling the driving unit,
wherein the controlling unit calculates respective evaluation values of the plurality of moving objects based on at least one of (a) information on the plurality of moving objects, (b) information on a shake of the image capturing apparatus, and (c) information on a driving state of the driving unit, and
wherein the controlling unit controls the driving unit based on the evaluation values.

2. The image capturing apparatus according to claim 1, wherein the evaluation values are respective weight coefficients of the plurality of moving obj ects,
wherein the controlling unit calculates a center-of-gravity position of the plurality of moving objects based on positions and the weight coefficients of the plurality of moving objects, and
wherein the controlling unit controls the driving unit based on the center-of-gravity position.

3. The image capturing apparatus according to claim 1, wherein the object detector calculates a shake vector of the image capturing unit based on the information on the driving state of the driving unit and the information on the shake of the image capturing apparatus, and
wherein the object detector detects the plurality of moving objects based on vectors acquired by subtracting the shake vector from the motion vectors.

4. The image capturing apparatus according to claim 1, wherein the controlling unit calculates the evaluation values based on at least one of (a) sizes of the plurality of moving objects, (b) velocities of the plurality of moving objects, (c) moving directions of the plurality of moving objects, (d) numbers of detected vectors of the plurality of moving objects, (e) variances of the detected vectors of the plurality of moving objects, and (f) detection information of a specific object near the plurality of moving objects.

5. The image capturing apparatus according to claim 1, wherein in a case where a shake amount of the image capturing apparatus is a first shake amount, the controlling unit sets an evaluation value of a moving object detected by the object detector to a first evaluation value, and
wherein in a case where the shake amount is a second shake amount larger than the first shake amount, the controlling unit sets the evaluation value to a second evaluation value smaller than the first evaluation value.

6. The image capturing apparatus according to claim 1, wherein in a case where a shake amount of the image capturing apparatus is a first shake amount, the object detector sets a detection condition of each of the moving objects to a first condition, and
wherein in a case where the shake amount is a second shake amount larger than the first shake amount, the object detector sets the detection condition to a second condition which is a more limited condition than the first condition.

7. The image capturing apparatus according to claim 1, wherein in a case where a shake amount of the image capturing apparatus is a first shake amount, the controlling unit sets a tracking amount in the tracking control to a first tracking amount, and
wherein in a case where the shake amount is a second shake amount larger than the first shake amount, the controlling unit sets the tracking amount to a second tracking amount smaller than the first tracking amount.

8. The image capturing apparatus according to claim 1, wherein in a case where a velocity of the driving unit is a first velocity, the controlling unit sets an evaluation value of a moving object detected by the object detector to a first evaluation value, and
wherein in a case where the velocity is a second velocity faster than the first velocity, the controlling unit sets the evaluation value to a second evaluation value smaller than the first evaluation value.

9. The image capturing apparatus according to claim 1, wherein in a case where a velocity of the driving unit is a first velocity, the object detector sets a detection condition of each of the moving objects to a first condition, and
wherein in a case where the velocity is a second velocity faster than the first velocity, the object detector sets the detection condition to a second condition which is a more limited condition than the first condition.

10. The image capturing apparatus according to claim 1, wherein in a case where a velocity of the driving unit is a first velocity, the controlling unit sets a tracking amount in the tracking control to a first tracking amount, and
wherein in a case where the velocity is a second velocity faster than the first velocity, the controlling unit sets the tracking amount to a second tracking amount smaller than the first tracking amount.

11. The image capturing apparatus according to claim 1, wherein the controlling unit performs the tracking control during motion image capturing.

12. The image capturing apparatus according to claim 1, further comprising a panning-tilting unit configured to cause the image capturing unit to horizontally or vertically rotate, and
wherein the driving unit drives the panning-tilting unit.

13. An image capturing apparatus comprising:
an image capturing unit;
a driving unit configured to drive the image capturing unit; and
at least one processor configured to function as:
a motion vector detector configured to detect a motion vector based on image data output from the image capturing unit;
an object detector configured to detect a moving object based on the motion vector or a specific object; and
a controlling unit configured to perform tracking control by controlling the driving unit,
wherein the controlling unit sets a reference position for the image capturing unit, and
wherein the controlling unit determines whether or not to move the image capturing unit to the reference position, based on at least two of (a) a time during which a position of the image capturing unit is away from the reference position, (b) an angular amount by which the position of the image capturing unit is away from the reference position, (c) detection information of the moving object, and (d) detection information of the specific object.

14. The image capturing apparatus according to claim 13, wherein the reference position is set according to an instruction by a user.

15. The image capturing apparatus according to claim 13, wherein the reference position is a position at which motion image capturing starts.

16. The image capturing apparatus according to claim 13, further comprising a panning-tilting unit configured to cause the image capturing unit to horizontally or vertically rotate, and
wherein the driving unit drives the panning-tilting unit.

17. A control method of an image capturing apparatus including an image capturing unit, a driving unit configured to drive the image capturing unit, and at least one processor configured to function as a motion vector detector configured to detect motion vectors based on image data output from the image capturing unit, an object detector configured to detect a plurality of moving objects based on the motion vectors, and a controlling unit configured to perform tracking control by controlling the driving unit, the control method comprising:
calculating respective evaluation values of the plurality of moving objects based on at least one of (a) information on the plurality of moving objects, (b) information on a shake of the image capturing apparatus, and (c) information on a driving state of the driving unit, and
performing the tracking control by controlling the driving unit based on the evaluation values calculated in the calculating.

18. A control method of an image capturing apparatus including an image capturing unit, a driving unit configured to drive the image capturing unit, and at least one processor configured to function as a motion vector detector configured to detect a motion vector based on image data output from the image capturing unit, an object detector configured to detect a moving object based on the motion vector or a specific object, and a controlling unit configured to perform tracking control by controlling the driving unit, the control method comprising:
acquiring a reference position for the image capturing unit, and
determining whether or not to move the image capturing unit to the reference position, based on at least two of (a) a time during which a position of the image capturing unit is away from the reference position, (b) an angular amount by which the position of the image capturing unit is away from the reference position, (c) detection information of the moving object, and (d) detection information of the specific object.

19. A non-transitory computer-readable memory medium storing a computer program that causes a computer to execute the control method according to claim 17.

20. A non-transitory computer-readable memory medium storing a computer program that causes a computer to execute the control method according to claim 18.
